(19) United States
(12) Patent Application Publication
(10) Pub. No.: US 2025/0211970 A1
(43) Pub. Date: Jun. 26, 2025

(54) Profile Activation and Selection Triggers for Embedded Universal Integrated Circuit Card

(71) Applicant: Apple Inc., Cupertino, CA (US)

(72) Inventors: Nitin Kuppelur, Bangalore (IN); Stanley M. Mayalil, San Jose, CA (US); Hyewon Lee, Cupertino, CA (US); Vivek G. Gupta, San Jose, CA (US); Deepak Dash, Bangalore, IN (US); Dipannita Dey, Bangalore (IN)

(21) Appl. No.: 18/393,382

(22) Filed: Dec. 21, 2023

(51) Int. Cl. H04W 8/18

(52) U.S. Cl. CPC H04W 8/183

(57) ABSTRACT

A UE and UE peripheral device are described. The UE can perform receiving, at a local profile assistant (LPA) of the UE and via a local management interface, an attention (AT) command from a UE peripheral device; determining that the AT command is for an embedded universal integrated circuit card (eUICC) of the UE, the eUICC configured to support a plurality of eSIM profiles; providing a request to the eUICC according to the AT command; obtaining, from the eUICC responsive the request, an indication of a status of the request; providing an AT command response to the UE peripheral device via the local management interface, the AT command response based at least in part on the indication of the status.

### TECHNICAL FIELD

This application relates generally to wireless communication systems, including systems, apparatuses, and methods for profile activation and selection triggers for an embedded universal integrated circuit card.

### BACKGROUND

Wireless mobile communication technology uses various standards and protocols to transmit data between a network device (e.g., a base station, a radio head, etc.) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example signal flow, according to one or more aspects described herein.

FIG. 3 shows an example signal flow, according to one or more aspects described herein.

FIG. 4 shows an example signal flow, according to one or more aspects described herein.

FIG. 5 shows an example signal flow, according to one or more aspects described herein.

FIG. 6 shows an example signal flow, according to one or more aspects described herein.

FIG. 7 shows an example signal flow, according to one or more aspects described herein.

FIG. 8 shows an example signal flow, according to one or more aspects described herein.

FIG. 9 shows an example signal flow, according to one or more aspects described herein.

FIG. 10 shows an example signal flow, according to one or more aspects described herein.

FIG. 11 shows an example method of wireless communication by a UE, according to one or more aspects described herein.

FIG. 12 shows an example method of wireless communication by a UE peripheral device, according to one or more aspects described herein.

FIG. 13 illustrates an example architecture of a wireless communication system, according to embodiments described herein.

FIG. 14 illustrates an example system for performing signaling between a wireless device and a UE peripheral device, according to embodiments described herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

A UE or other mobile device may use a subscriber identity module (SIM) card to store information about a user of the UE. A SIM card is typically a small, portable memory chip that stores information about the user. For example, a SIM card typically has a seventeen-digit code that designates the country code of origin, the operate (e.g., a mobile network operator (MNO)), and a user ID. Rather than a physical card to be changed out or installed for different deployments, an eSIM (embedded SIM) may be embedded directly into a UE, such as a smartphone or Internet of Things (IoT) device, rather than being a physical, removable card. The term eSIM, as used herein, refers generally to remote SIM provisioning according to the Global System for Mobile Communications Association (GSMA). The eSIM is designed in part to replace traditional physical SIM cards. One advantage of eSIM technology is flexibility, as eSIM technology allows users to remotely provision and manage the user's mobile subscriptions without the need for a physical SIM card swap. This capability may particularly beneficial for devices with constrained physical space, such as smartwatches or connected IoT devices.

In some cases, an embedded universal integrated circuit card (eUICC) can be used. An eUICC is an embedded component that incorporates both the functionality of a traditional SIM card and an additional layer of programmability for managing multiple mobile subscriptions. An eUICC may be a removable or a non-removable UICC, and enables the remote and/or local management of profiles in a secure way. An eUICC may or multiple “eSIM profiles,” which may also be referred to herein as simply a “profile.” An eUICC may allow customers and equipment manufactures to more easily and conveniently provision a SIM with a new operator profile, for example by provisioning a new operator profile over the air.

Modern UEs typically have multiple eSIM profiles provisioned and activated by default. A user of the UE may switch between eSIM profiles. Although there exist methodologies defined for provisioning, activation, and switching eSIM profiles, UEs may lack a defined interfaces between a user and a baseband for performing available for provisioning, activation, and switching of eSIM profiles. In many cases, a lack of such interface may result in controlling or testing being blocked or otherwise unsupported, for example during conformance testing or lab testing when support by an access point (AP) or other network device is unavailable or not yet available, or configuring a lightweight IoT device with constrained user interface (UI).

An attention (AT) command is a communication instruction used for controlling and configuring mobile devices, including UEs and their associated modems and modules. AT commands may be transmitted to a UE as a series of characters prefixed with “AT.” The AT commands may be used to enable the initiation of various operations, such as establishing a connection, querying device information, or configuring parameters at the UE. AT commands may thus enable the interaction between external applications or equipment and the UE, facilitating the management and customization of communication settings. For example, for eUICC devices, how a profile is enabled, disabled, and/or deleted is left to UE implementation. Having a standard method is helpful, for example for testing (e.g., according to a 3GPP CT6, 3GPP RAN5 Test specification) for non-removable UICC (nrUICC) devices.

As such, one or more AT commands that facilitate aspects of eSIM profile activation and selection triggers are described herein. In some examples, such AT commands may be used at least for the testing of eSIM devices with eSIM profiles. AT commands for eUICCs include AT commands to: download and install a profile (e.g., through activation code procedure); enable or disable an installed profile; delete a profile; add and/or update a nickname to a profile; query metadata for a profile; reset a memory of an eUICC; edit a default subscription manager data preparation platform (SM-DP+) address; list, send, and/or delete a pending notification; or get an eUICC identifier (EID). One or more of these AT commands may be incorporated into or provide a base for development of a test specification for eUICCs, including for nrUICC devices, for example associated with 3GPP TS 31.117 and/or 3GPP TS 31.127. One or more of these AT commands may be incorporated into or provide a base for development of a test specification for IoT devices (e.g., IoT devices that do not have a UI or standard interface for testing), for example associated with a GSMA SGP.26 test specification. One or more of these AT commands may be incorporated into or provide a base for one or more of 3GPP global certification forum (GCF) or personal communication service (PCS) type certification review board (PTCRB) testing, carrier testing, or vendor and third party lab testing where the test execution will be automated through AT commands.

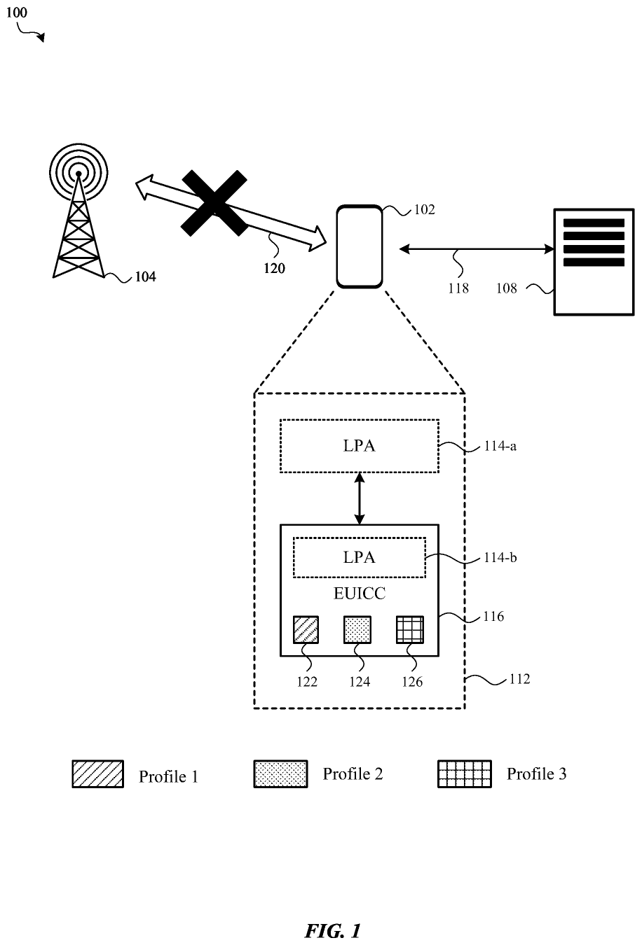

FIG. 1 shows an example wireless communications system 100, according to one or more aspects described herein. In one or more embodiments, wireless communications system 100, supports one or more aspects of profile activation and selection triggers for an eUICC, as further described herein.

Wireless communications system 100 includes a UE 102 and a UE peripheral device 108. In one or more embodiments, UE 102 has not yet established a connection 120 with a network device 104, for example because the UE 102 is being tested prior to deployment, use, or configuration in a network that includes the network device 104. In one or more embodiments, UE 102 is associated with a universal SIM (USIM), such as an eUICC 116. The combination of the UE 102 and eUICC 116 is a mobile station (MS) 112. As used herein, a component of UE 112 is also a component of MS 112.

In one or more embodiment, MS 112 includes profile manager circuitry, such as a local profile assistant (LPA) 114 coupled with an eUICC 116. In some embodiments, LPA 114 is a part of the eUICC 116 (e.g., LPA 114-b). In other embodiments, LPA 114 is a separate component from the eUICC 116 (e.g., LP. A 114-a). In either configuration, the LPA 114 is coupled to the eUICC 116 for communication.

In one or more embodiments, the eUICC 116 is configured to support a plurality of eSIM profiles, for example a first eSIM profile 122, a second eSIM profile 124, and a third eSIM profile 126. Although three eSIM profiles are illustrated, any number of eSIM profiles may be supported, configured, or used at the eUICC 116.

In one or more embodiments, UE peripheral device 108 may be, e.g., a UE testing device or a UE extension device augmenting UI. UE peripheral device 108 is coupled with the MS 112 via a local management interface 118. The UE peripheral device 108 connects to the UE 102 with a generic port. Hence, the UE peripheral device 108 interacts to eUICC 116 via a logical interface. In one or more embodiments, local management interface 118 includes circuitry of the UE 102, MS 112, or both, that supports communications with the UE peripheral device 108, and circuitry of the UE peripheral device 108 that supports communications with the UE 102, the MS 112, the LPA, or a combination of these.

In one or more embodiments, the eUICC 116 may allow a user (e.g., a user of the UE 102) to choose between multiple MNO profiles. In some embodiments, the eUICC 116 may be a discrete chip or integrated circuit component, for example mounted on a printed circuit board of the UE 102. In other embodiments, the eUICC 116 may be incorporated into an integrated circuit chip, module, or assembly with other components or circuits of UE 102, such as a modem or baseband.

In one or more embodiments, the LPA 114 is a functional element that provides service for eUICC operations. In some embodiments, the LPA 114 is implemented as a portion of a standalone or discrete chip or integrated circuit device, for example mounted on a printed circuit board of the UE 102. In some embodiments, the LPA 114 is implemented as a part of an application processor, a modem, a baseband, or other component of the MS 112. In some embodiments, the LPA 114 is a part of the eUICC 116, for example circuitry that is a part of the same chip or integrated circuit as eUICC 116.

LPA 114 is generally a set of function of the UE 102 responsible for providing the capability to download encrypted profiles to the eUICC 116. LPA 114 may also present the local management interface 118, which may also be or be referred to as a local management interface 118, to the end user (e.g., UE peripheral device 108), so that the end user can manage the status of profiles on the eUICC 116 (e.g., one or more of the first eSIM profile 122, the second eSIM profile 124, and the third eSIM profile 126). As described herein, one or more of the functions of the LPA 114 may be built into the eUICC 116.

LPA 114 includes one or more sets of circuitry responsible for different services or otherwise perform different tasks of the LPA 114. As such, LPA 114 has one or more set of functions responsible for different services or tasks. For example. LPA 114 may include one or more of a local discovery service (LDS) that interfaces with a subscription manager discovery service (SM-DS), for example external to UE 102; a local profile download (LPD) that interfaces with a subscription manager data preparation (SM-DP+), for example external to UE 102; and a local user interface (LUI) that interfaces with one or more of device applications of UE 102, a high resolution icon (HRI) server, or an end user, for example the UE peripheral device 108.

In one or more embodiments, an SM-DS is a function that helps abstract an eUICC from operation connection. The SM-DS may allow SM-DP+ to post alerts to a secure noticeboard and for devices to extract the alerts. The SM-DS may be used to notify the LPA 114 when profile (e.g., eSIM profile) data is available for download to the eUICC 116. The LPA 114 may poll the SM-DS for notification, for example when needed by UE 102.

In one or more embodiments, an SM-DP+ is responsible for the creation, download, remote management (e.g., enable, disable, update, delete) and the protection of operator credentials (e.g., the profile)

In one or more embodiments, UE peripheral device 108 may transmit or otherwise provide AT commands to the UE 102, and the UE 102 may receive or otherwise obtain the AT commands from the UE peripheral device 108. In response to such AT commands, the UE 102 may transmit or otherwise provide results (e.g., TA command results) to the UE peripheral device 108, and the UE peripheral device 108 may receive or otherwise obtain the results from the UE 102. In one or more embodiments, as further described herein, such AT commands (and results associated with such AT commands) include one or more of AT commands to: download and install a profile (e.g., through activation code procedure); enable or disable an installed profile; delete a profile; add and/or update a nickname to a profile; query metadata for a profile; reset a memory of an eUICC; edit a default subscription manager data preparation platform (SM-DP+) address; list, send, and/or delete a pending notification; or get an EID.

In the context of 3GPP technology and mobile communication devices (e.g., UEs, including their modems and cellular modules), AT commands are used to control and configure the device. AT commands may be issued through a communication interface, such as a serial interface (e.g., universal asynchronous receiver-transmitter (UART) or universal serial bus (USB)). In some embodiments, the AT commands are ASCII character strings and start with a prefix of “AT.” In some embodiments, an AT command is sent from the UE peripheral device 108 to the UE 102 using a chosen interface (e.g., the local management interface 118). AT command can be sent programmatically through software running on the UE peripheral device 108, which may be a computer or microcontroller, including processors and memories configurable or programmable for UE testing.

In some embodiments, AT commands have a specific syntax, such as the “AT” prefix, followed by a specific command and optional parameters, as further discussed below. A response to the AT command, (e.g., an AT command response, or AT command result) may include information or an acknowledgment. The response can include the result of the command or information about the current state of the UE (e.g., of a modem, or the eUICC 116). In some embodiments, such responses are in the form of a text string that can be interpreted programmatically. In some cases, the AT command may return an error, for example in case of an issue with the AT command or if the UE (e.g., the eUICC 116) is unable to execute the AT command. In some embodiments, the error response starts with “ERROR.” As further described herein, AT commands for profile activation and selection triggers for the eUICC 116 may be defined as a set of standalone AT commands that are common across compliant devices, such as a UE 102, ensuring interoperability.

In one or more embodiments, an AT command and AT command response for an eUICC Profile Download +CEUICCPD may have a syntax as shown in Table 1 below.

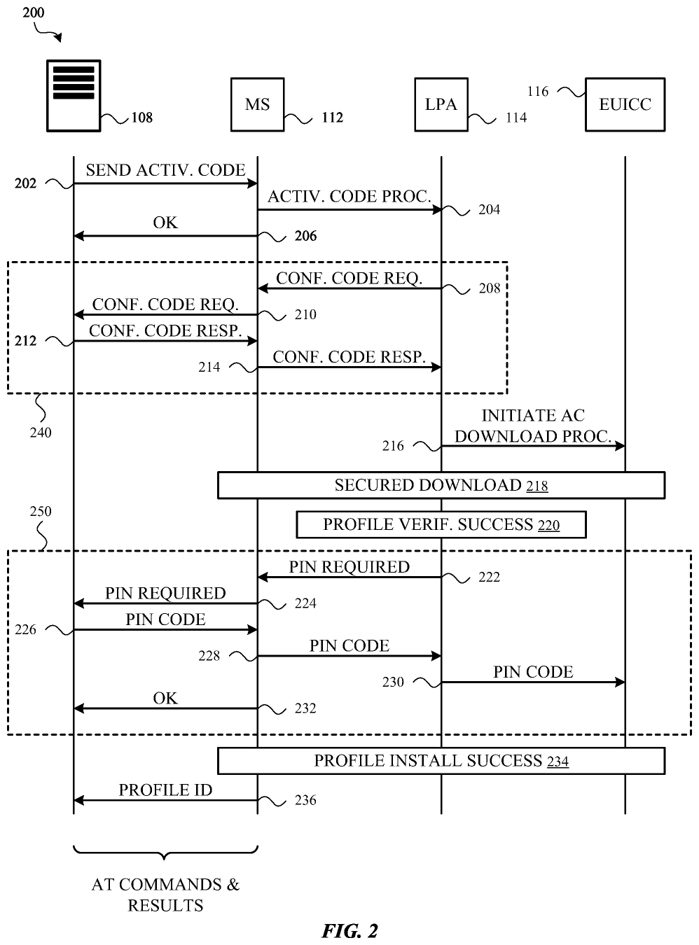

FIG. 2 shows an example signal flow 200, according to one or more aspects described herein. In one or more embodiments, signal flow 200, supports one or more aspects of profile activation and selection triggers for an eUICC, as further described herein. Signal flow 200 generally relates to a successful profile download.

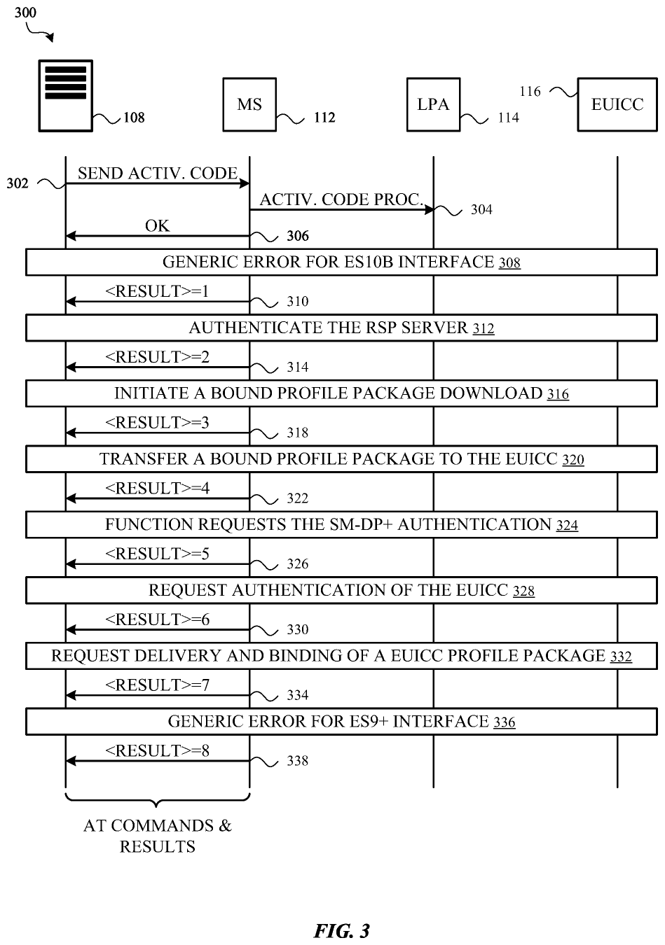

FIG. 3 shows an example signal flow 300, according to one or more aspects described herein. In one or more embodiments, signal flow 300, supports one or more aspects of profile activation and selection triggers for an eUICC, as further described herein. Signal flow 300 generally relates to an unsuccessful profile download, for example, where one or more errors are returned by the eUICC 116.

Signal flow 200 and signal flow 300 each illustrate communications between a UE peripheral device 108, a mobile station 112, an LPA 114, and an eUICC 116. In one or more embodiments, the LPA 114 and the eUICC 116 are a part of the mobile station 112. Mobile station 112 may be referred to as or be an example of UE 102. In some embodiments, mobile station 112 may include at least a portion of a local management interface, for example circuitry associated with local management interface 118. Additionally, or alternatively, in some embodiments, the UE peripheral device 108 may include at least a portion of the local management interface.

TABLE 1
+CEUICCPD parameter command syntax

| Command | Possible response(s) |
|---|---|
| +CEUICCPD=<mode>,<matching_ID>/<confirmation_code>[,<smdp_address>] | +CME ERROR: <err> |
| +CEUICCPD=? | |

Table 1 illustrates a +CEUICCPD parameter command syntax (e.g., for eSIM profile download), including in relation to signal flow 200 and signal flow 300. The set command is to invoke the LPA 114 (present in eUICC 116 and/or MS 112) to trigger a request to download and install a profile in an eUICC through an Activation Code procedure. In case a default SM-DP+address is already present in the eUICC 116 and/or MS 112, the same SM-DP+ may be used and user may skip to provide the same.

The command returns with the response depending upon whether the request is successfully sent to LPA, or not. The actual result for the download and installation is displayed through the unsolicited result code:
+CEUICCPDU: <result>[,[<iccid>][,<cause_source>[,<cause>]]]
   once the activation procedure ends.

Optionally, if the Activation code token indicates that a confirmation code is also required, the user is prompted through +CEUICCPDU to input a Confirmation Code provided to them by the issuing MSP. The set command can be used to respond with the confirmation code.

Defined values:
<mode>: integer type:
0 send activation code
1 send confirmation code

<confirmation_code>: string type, indicates the confirmation code that is to be used to download and install the profile from SM-DP+. This is procured from the Mobile Service Provider (MSP) while subscribing through external means. If <mode>=1, <confirmation_code> needs to be provided.

<matching_ID>: string type, indicates the matching ID that is to be used to download and install the profile from SM-DP+. If <mode>=0, <matching_ID> needs to be provided.

<smdp_address>: string type, indicates the address for SM-DP+ (Subscription Manager Data Preparation +). This is used by LPA to identify the SM-DP+ where the Profile is stored and available for download.

<result>: integer type; indicates the final result for downloading and installing a profile.
0 Successfully downloaded and installed.
1 Failed to download and install.
2 Confirmation code required.
3 Successfully downloaded but PIN locked. Refer +CPIN to unlock.

<iccid>: string type; specifies a unique number to identify a Profile in an eUICC.

<cause_source>: integer type, indicating the function returning the error cause while the procedure download and install is being executed for a profile. These functions are associated to a particular eUICC interface, for example ES9+ is used to provide a secure transport between the SM-DP+ and the LPA for the delivery of the Profile Package and ES10b is used by the LPA to transfer a Profile Package to the eUICC. <cause_source> will be present when <result>=1 Refer GSMA SGP.22.
0 unknown
1 generic error for ES10b interface.
2 function performs the authentication of the RSP Server by the eUICC (AuthenticateServer,ES10b)
3 function initiates a Bound Profile Package download after a successful authentication of an SM-DP+(PrepareDownload,ES10b).
4 function transfers a Bound Profile Package to the eUICC(LoadBoundProfilePackage,ES10b)
5 function requests the SM-DP+ authentication (InitiateAuthentication,ES9+)
6 function called by the LPA to request the authentication of the eUICC by the SM-DP+(AuthenticateClient,ES9+)
7 function called to request the delivery and the binding of a Profile Package for the eUICC(GetBoundProfilePackage,ES9+)
8 generic error for ES9+ interface

<cause>: integer type, indicating the error cause because of which the procedure of downloading and installing a profile has been terminated. <cause> will be present when <result>=1 Refer GSMA SGP.22:

| | | | |
|---|---|---|---|
| 0 | undefined error | 1 | invalid certificate |
| 2 | invalid signature | 3 | unsupported curve |
| 4 | no session context | 5 | invalid OID |
| 6 | eUICC challenge mismatch | 7 | CI PK unknown |
| 8 | invalid transaction id | 9 | incorrect input values |
| 10 | unsupported CRT values | 11 | unsupported Remote |
| | | | Operation Type |
| 12 | unsupported Profile Class | 13 | SCP03t Structure Error |
| 14 | SCP03t Security Error | 15 | install failed due to iccid |
| | | | already exists on eUICC |
| 16 | install failed due to | 17 | install failed due to |
| | insufficient memory for profile | | interruption |
| 18 | install failed due to PE | 19 | install failed due to data |
| | Processing Error | | mismatch |
| 20 | test profile install failed due | 21 | PPR not allowed |
| | to invalid NAA key | | |
| 22 | incorrect values in command | 23 | reference data not found |
| | data | | |
| 24 | Conditions of use not satisfied | 25 | Invalid SM-DP+ address |
| 26 | eUICC specification version | 27 | security configuration |
| | not supported by SM-DP+. | | unsupported |
| 28 | CI PK Id not supported | 29 | EUM certificate invalid |
| 30 | EUM certificate expired | 31 | eUICC certificate invalid |
| 32 | eUICC certificate expired | 33 | eUICC signature invalid |
| 34 | eUICC insufficient memory | 35 | CI PK Unknown |
| 36 | profile not allowed | 37 | transaction ID unknown |
| 38 | matchingId refused | 39 | EID Mismatch |
| 40 | download order max retries | 41 | download order time to live |
| | exceeded | | expired |
| 42 | BPP rebinding refused | 43 | Confirmation Code missing |
| 44 | Confirmation Code refused | 45 | Confirmation Code max |
| | | | retires exceeded |

Referring to signal flow 200, at 202, an AT command indicating an activation code is sent to UE 102. In one or more embodiments, the AT command is AT+CEUICCPD=0, “matching_ID”, “smdp_address”.

At 204, a message is sent from the mobile station 112 to LPA 114 indicating for the LPA 114 to perform an activation code procedure according to one or more activation code parameters. In some embodiment, 204 includes a UE operating to receive, via a local management interface, an AT command from a UE peripheral device 108. In some embodiments, the UE may determine that the AT command includes a request to perform an activation code procedure to download and install an eSIM profile in the eUICC 116, where the request provided to the eUICC 116 includes an indication to initiate an activation code download procedure. In one or more embodiments, the message at 204 may identifying one or more parameters associated with the activation code, as further described herein.

At 206, MS 112 may send, to UE peripheral device 108, a confirmation (“OK”).

Optional signaling 240 may be performed, for example if the confirmation code is required. At 208, LPA 114 send a confirmation code request to the MS 112, which sends an unsolicited response 210 (e.g., +CEUICCPD:2) to the UE peripheral device 108 indicating the confirmation code request. The UE peripheral device 108 returns an AT command indicating a confirmation code response 212 (e.g., AT+CEUICCPD=1 “confirmation code”), and MS 112 sends the confirmation code response 214 to the LPA 114.

At 216, a request is provided to the eUICC 116 according to the AT command received at 202. The LPA 114 send a message to the eUICC 116 indicating to initiate the activation code download procedure. At 218, a secured download is performed for the activation code from the eUICC 116 to the MS 112. At 220, profile verification is performed by the LPA 114, and in one or more embodiment, the verification may be determined to by successful.

Optional signaling 250 may be performed, for example if a PIN is requested or required for the profile. At 222, LPA 114 sends an indication that a PIN is required to the MS 112, which sends an AT command response 224 (e.g., +CEUICCPD:3) to the UE peripheral device 108 indicating the request for the PIN. At 226, the UE peripheral device 108 returns an AT command indicating the PIN (e.g., AT+CPIN=<pin>), and MS 112 sends the PIN code to the LPA 114 at 228, and at 230, the LPA 114 sends the PIN code (e.g., for the eSIM profile) to the eUICC 116. A confirmation may be sent from the MS 112 to the UE peripheral device 108 at 232.

At 234, the profile is installed, and may be successfully installed (e.g., without, or using the PIN code, optionally). In some embodiments, 234 is an example of obtaining, from the eUICC 116 responsive the request, an indication of a status of the request.

At 236, an AT command response indicating a profile identifier (ID) for the installed profile is sent to the UE peripheral device 108. In some embodiments, 236 is an example of providing an AT command response in response to the UE peripheral device via the local management interface, the AT command response based at least in part on the indication of the status.

Referring to signal flow 300, 302 may be an example of 202, 304 may be an example of 204, and 306 may be an example of 206. However, eUICC 116 may return one or more errors, in response to 304, such that when <result>=1, <cause_source> is present for the AT command response (e.g., <result> is one of 0 through 8), as further described above. For example if a generic error for the ES10B interface at 308 occurs, this results in an AT command response at 310 (e.g., <result>=1, and +CEUICCPDU: 1 , , , 1,22). In another example, if a function perform the authentical of the remote SIM provisioning (RSP) server by the eUICC at 312, this results in an AT command response at 314 (e.g., <result>=2, and +CEUICCPDU: 1 , , , 2,1). In another example, if the function initiates a BPP download after a successful authentication of an SM-DP+ at 316, this results in an AT command response at 318 (e.g., <result>=3, and +CEUICCPDU: 1 , , , 3,2). In another example, if the function transfers a bound profile package (BPP) to the eUICC at 320, this results in an AT command response at 322 (e.g., <result>=4, and +CEUICCPDU: 1 , , , 4,9). In another example, if the function request the SM-DP+ authentication at 324, this results in an AT command response at 326 (e.g., <result>=5, and +CEUICCPDU: 1 , , , 5,25). In another example, if the function called by the LPA to request the authentical of the eUICC by the SM-DP+ at 328, this results in an AT command response at 330 (e.g., <result>=6, and +CEUICCPDU: 1 , , , 6,29). In another example, if the function is called to request the delivery and the binding of a profile package at 332, this results in an AT command response at 330 (e.g., <result>=7, and +CEUICCPDU: 1 , , , 7,43). In another example, if a generic error of the ES9+ interface occurs at 336, this results in an AT command response at 338 (e.g., <result>=8, and +CEUICCPDU: 1 , , , 8,0). In some embodiments, in the case a returned error, though multiple are shown in signal flow 300, in some examples, a single one of 308, 312, 316, 320, 324, 328, 332, or 336 may occur, resulting in one of 310, 314, 318, 322, 326, 330, 334, or 338, respectively.

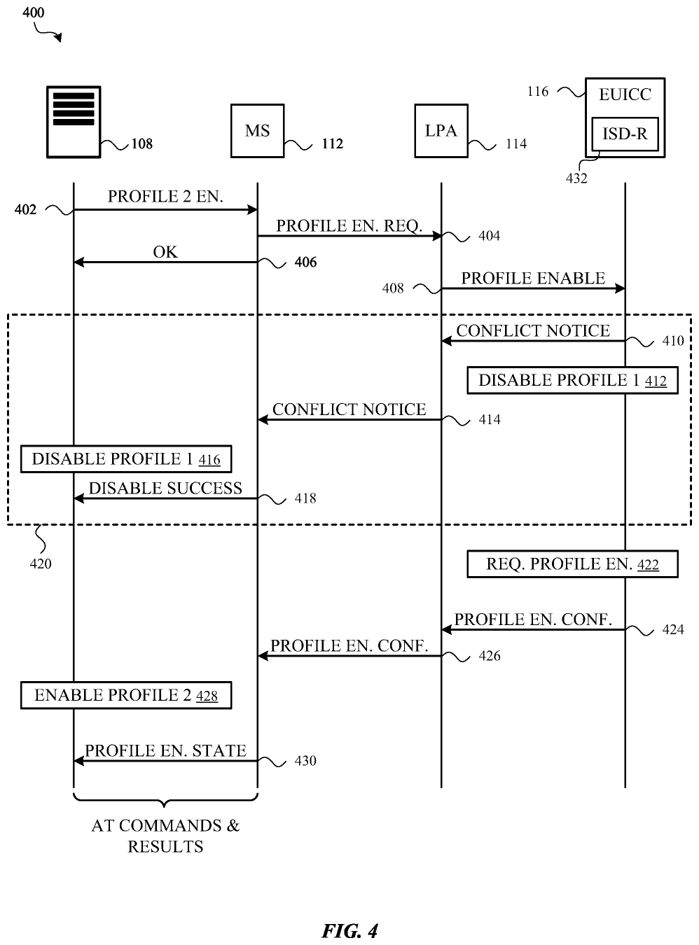

FIG. 4 shows an example signal flow 400, according to one or more aspects described herein. In one or more embodiments, signal flow 400 supports one or more aspects of profile activation and selection triggers for an eUICC, as further described herein. Signal flow 400 generally relates to enabling a profile.

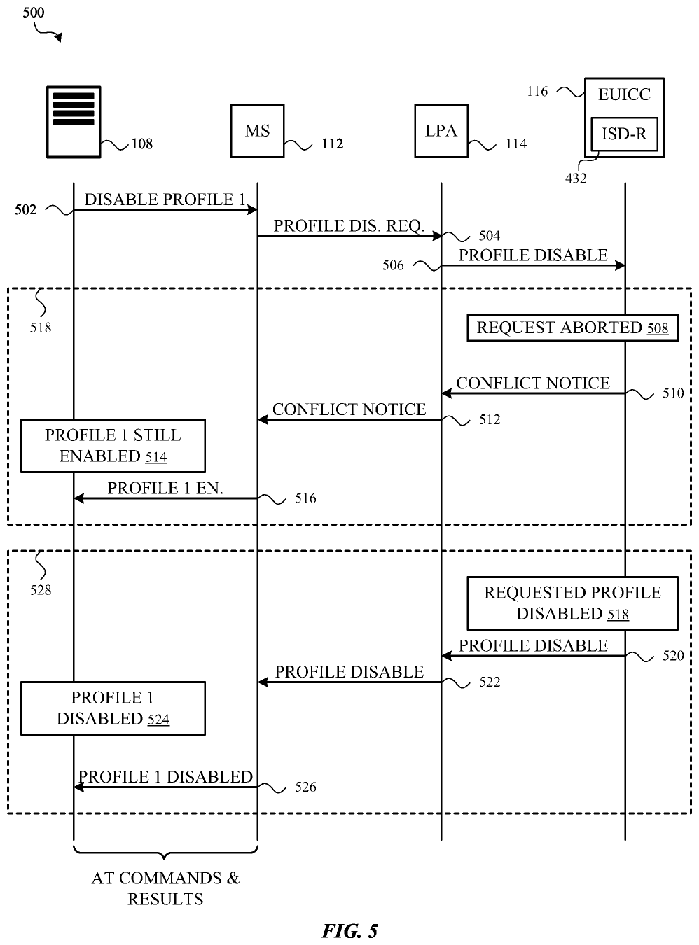

FIG. 5 shows an example signal flow 500, according to one or more aspects described herein. In one or more embodiments, signal flow 500 supports one or more aspects of profile activation and selection triggers for an eUICC, as further described herein. Signal flow 500 generally relates to disabling a profile.

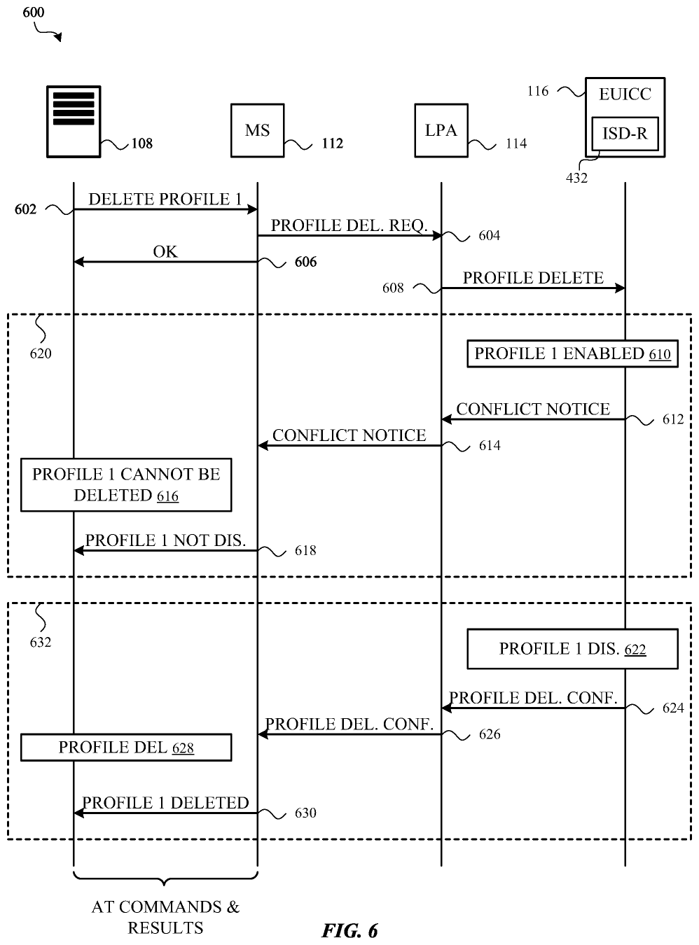

FIG. 6 shows an example signal flow 600, according to one or more aspects described herein. In one or more embodiments, signal flow 600 supports one or more aspects of profile activation and selection triggers for an eUICC, as further described herein. Signal flow 600 generally relates to deleting a profile.

Signal flow 400, signal flow 500, and signal flow 600 each illustrate communications between a UE peripheral device 108, a mobile station 112, an LPA 114, and an eUICC 116. In one or more embodiments, the LPA 114 and the eUICC 116 are a part of the mobile station 112. Mobile station 112 may be referred to as or be an example of UE 102. In some embodiments, mobile station 112 may include at least a portion of a local management interface, for example circuitry associated with local management interface 118. Additionally, or alternatively, in some embodiments, the UE peripheral device 108 may include at least a portion of the local management interface. In one or more embodiments, communications with eUICC 116 may be more specifically with an issuer security domain-root (ISD-R) 432, which may be a portion or component of eUICC 116.

TABLE 2
+CEUICCPM parameter command syntax

| Command | Possible response(s) |
|---|---|
| +CEUICCPM=<operation>,<iccid> | +CME ERROR: <err> |
| +CEUICCPM? | [+CEUICCPM: |
| | <iccid1>,<state>[,<iccid2>,<state> |
| | [...]]] |
| +CEUICCPM=? | +CEUICCPM: (range of supported <iccid>s), |
| | list of supported (<operation>s) |

Table 2 illustrates a +CEUICCPM parameter command syntax (e.g., for eSIM profile management), including in relation to signal flow 400, signal flow 500, and signal flow 600. The set command is to enable or disable or delete a profile in an eUICC. In some embodiments the set command is applicable for an eUICC 116 capable device having profile(s) installed in the eUICC 116. For devices supporting two simultaneous device cellular connections, simultaneously two profiles may be enabled. In some embodiments, to delete a profile, the profile must be disabled.

The command returns with the response depending upon whether the request is successfully sent to LPA 114 or not. The actual result for the operations will be displayed through the unsolicited result code +CEUICCPMU: <result>[,[<iccid>],[<state>][,<cause>]]] once the procedure ends.

If the verification of the user's intent for the action being executed is required, then the user is prompted to respond to the same. Refer command +CEUICCUIV.

The read command returns the current settings for each installed profile.

The test command returns the list of <iccid>s indicating the list of profiles installed and the list of <operation>s that shall be triggered.

Defined values:

<operation>: integer type, indicates the operation to be done for the profile management for the profiles installed in the eUICC.
0 disable profile
1 enable profile
2 delete profile

<iccid>: string type; specifies a unique number to identify a Profile in an eUICC.

<state>: integer type, indicating the current state of the profile.
0 disabled
1 enabled
2 deleted

<result>: integer type; indicates the final result for the action triggered by the user.
0 Successfully enabled/disabled/deleted a profile.
1 Failed to complete enabling/disabling/deleting a profile.

<cause>: integer type, indicating the error cause because of which the procedure enable/disable/delete a profile has been terminated. <cause> will be present when <result>=1 Refer GSMA SGP.22.
0 unknown
1 ICCID or AID not found
2 profile not in disabled state
3 profile not in enabled state
4 disallowed by policy
5 wrong profile re-enabling
6 busy (proactive session ongoing on the Target Port)

Referring to signal flow 400, at 402, an AT command indicating a profile enable is sent to UE 102. In one or more embodiments, the AT command is AT+CEUICCPM=1, “iccid2”.

At 404, a message is sent from the mobile station 112 to LPA 114 indicating a profile enabling request. At 406, MS 112 may send, to UE peripheral device 108, a confirmation (“OK”), and the LPA 114 sends a profile enable signal to the ISD-R 432 at 408.

Optional signaling 420 may be performed, for example if a first profile (e.g., iccid1) is already enabled and multiple enabled profiles is not supported. At 410, a profile policy rule conflict notification is sent to LPA 114, and ISD-R 432 disables at 412 a profile (e.g., a profile “iccid1,” which is different than the profile iccid2 requested to be enabled). At 414, LPA 114 sends a profile policy rule conflict notification to MS 112. At 418, an AT command response (e.g., +CEUICCPMU:0, “iccid1”) indicating that the conflicted profile (e.g., “iccid1”) is disabled. At 416, UE peripheral device 108 disables or recognizes as disabled the conflicted profile (e.g., “iccid1”).

At 422 the request profile is enabled at ISD-R 432. A confirmation of the profile enablement is sent to LPA 114 at 424, and to MS 112 at 426. At 218, an AT command response (e.g., +CEUICCPMU:0, “iccid2”, 1) indicating that the profile (e.g., “iccid2”) requested to be enabled is enabled. At 430, UE peripheral device 108 enables or recognizes as enabled the requested profile (e.g., “iccid2”).

Referring to signal flow 500, at 502, an AT command indicating a profile disable is sent to UE 102. In one or more embodiments, the AT command is AT+CEUICCPM=0, “iccid1.”

At 504, a message is sent from the mobile station 112 to LPA 114 indicating a profile disabling request. At 506, the LPA 114 sends a profile disable signal to the ISD-R 432.

Optional signaling 518 may be performed, for example if a profile disable (e.g., for iccid1, or generally) is not allowed. At 508, the request may be aborted, and at 510 a profile policy rule conflict notification is sent to LPA 114. At 512, LPA 114 sends a profile policy rule conflict notification to MS 112. At 516, an AT command response (e.g., +CEUICCPMU:1, “iccid1”, 1) indicating that the profile is enabled. At 514, UE peripheral device 108 continues to enable or recognize as enabled the profile (e.g., “iccid1”).

Optional signaling 528 may be performed, for example if a profile disable (e.g., for iccid1, or generally) is allowed. At 518, the requested profile may be disabled, and at 520 a profile disable confirmation is sent to LPA 114. At 522, LPA 114 sends the profile disable confirmation to MS 112. At 526, an AT command response (e.g., +CEUICCPMU:0, “iccid1”, 0) indicating that the profile (e.g., “iccid1”) is disabled. At 524, UE peripheral device 108 disables or recognizes as disabled the profile (e.g., “iccid1”).

Referring to signal flow 600, at 602, an AT command indicating a profile delete is sent to UE 102. In one or more embodiments, the AT command is AT+CEUICCPM=2, “iccid1.”

At 604, a message is sent from the mobile station 112 to LPA 114 indicating a profile deletion request. At 606, MS 112 may send, to UE peripheral device 108, a confirmation (“OK”), and the LPA 114 sends a profile deletion signal to the ISD-R 432 at 608.

Optional signaling 620 may be performed, for example if a profile delete (e.g., for iccid1, or generally) is not allowed. At 610, the request may be aborted, and at 612 a profile policy rule conflict notification is sent to LPA 114. At 614, LPA 114 sends a profile policy rule conflict notification to MS 112. At 618, an AT command response (e.g., +CEUICCPMU:1, “iccid1”, 1, 2) is sent to UE peripheral device 108, and UE peripheral device 108 continues to enable or recognize as enabled the profile (e.g., “iccid1”), for example because the profile cannot be deleted as the profile is not in a disabled state.

Optional signaling 632 may be performed, for example if a profile delete (e.g., for iccid1, or generally) is allowed. At 622, the requested profile may be deleted, and at 624 a profile delete confirmation is sent to LPA 114. At 626, LPA 114 sends the profile delete confirmation to MS 112. At 630, an AT command response (e.g., +CEUICCPMU:0, “iccid1”, 2) indicating that the profile (e.g., “iccid1”) is deleted. At 628, UE peripheral device 108 disables or recognizes as disabled the profile (e.g., “iccid1”).

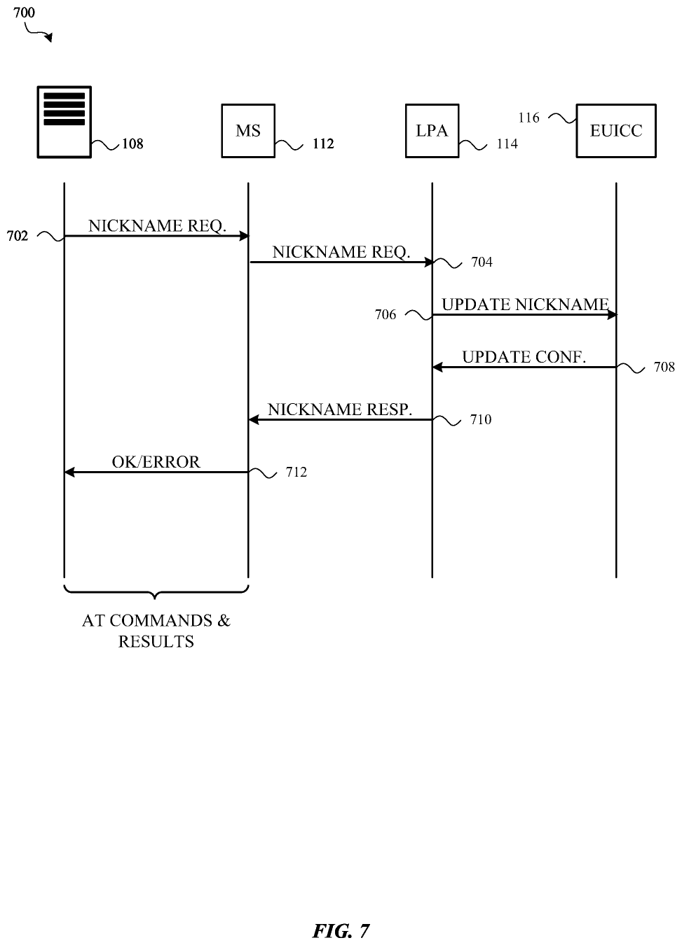

FIG. 7 shows an example signal flow 700, according to one or more aspects described herein. In one or more embodiments, signal flow 700 supports one or more aspects of profile activation and selection triggers for an eUICC, as further described herein. Signal flow 700 generally relates to updating a nickname for a eSIM profile.

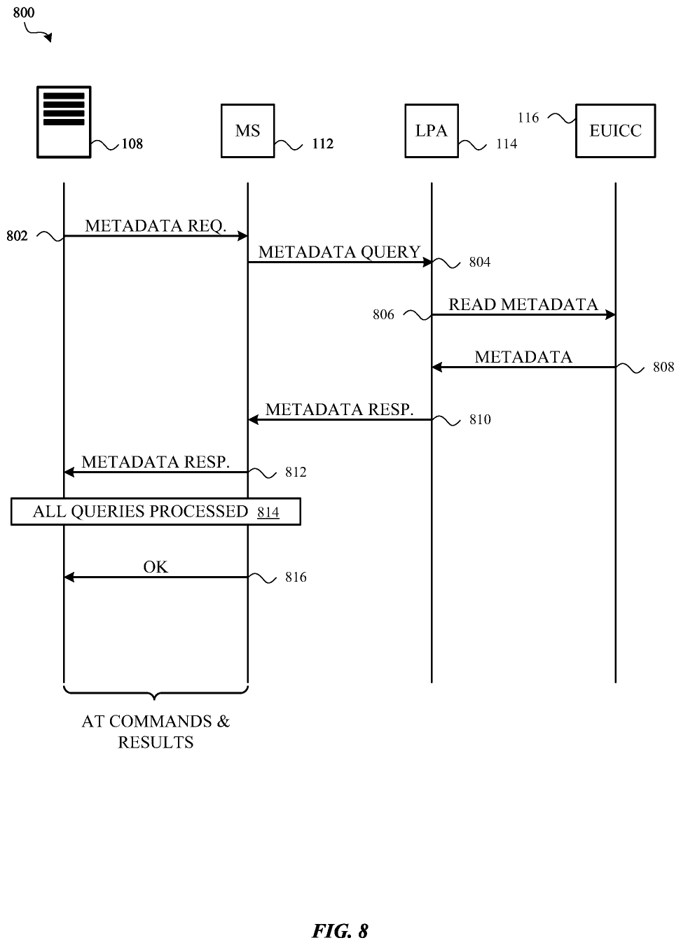

FIG. 8 shows an example signal flow 800, according to one or more aspects described herein. In one or more embodiments, signal flow 800, supports one or more aspects of profile activation and selection triggers for an eUICC, as further described herein. Signal flow 800 generally relates to reading metadata of a eSIM profile.

Signal flow 700 and signal flow 800 each illustrate communications between a UE peripheral device 108, a mobile station 112, an LPA 114, and an eUICC 116. In one or more embodiments, the LPA 114 and the eUICC 116 are a part of the mobile station 112. Mobile station 112 may be referred to as or be an example of UE 102. In some embodiments, mobile station 112 may include at least a portion of a local management interface, for example circuitry associated with local management interface 118. Additionally, or alternatively, in some embodiments, the UE peripheral device 108 may include at least a portion of the local management interface.

TABLE 3
+CEUICCPMETAI parameter command syntax

| Command | Possible response(s) |
|---|---|
| +CEUICCPMETAI[=<operation>[,<iccid>[< | [+CEUICCPMETAI: |
| nickname>]]] | <iccid>,<state>,<profile_metadata> |
| | [<CR><LF>+CEUICCPMETAI: |
| | <iccid>,<state>,<profile_metadata> |
| | [...]]] |
| | +CME ERROR: <err> |
| +CEUICCPMETAI=? | +CEUICCPMETAI: (range of supported |
| | <operation>s) |

Table 3 illustrates a +CEUICCPMETAI parameter command syntax (e.g., for eSIM profile metadata information), including in relation to signal flow 700 and signal flow 800. The set command is to allow the user (e.g., UE peripheral device 108) to read and display the profile metadata information for all the profiles installed in the eUICC irrespective of the state of the profile. The command also allows the user to attribute a nickname to a profile, for example for ease of use. In some embodiments, adding or changing a nickname does not affect any other data or other profile metadata for that profile.

The test command returns the list of <operation>s that are triggered.

Defined values:

<operation>: integer type, indicates the operation to be done for the profile management for the profiles installed in the eUICC.
0 Read the profile metadata for all the profiles(default)
1 Read the profile metadata for the profile identified by <iccid>. In this case, <iccid> needs to be provided.
2 Add/Update the nickname for a particular profile in the profile metadata. In this case, <iccid> and <nickname> needs to be provided

<iccid>: string type; specifies a unique number to identify a Profile in an eUICC.

<nickname>: string type, indicating a nickname that needs to be added/updated for a profile identified by <iccid>.

<state>: integer type, indicating the current state of the profile.
0 disabled
1 enabled

<profile_metadata>: string type, indicating the profile metadata information for a profile, including the following listed information. In some embodiments, the list of information that this command displays may be implementation specific.
MSP name
ICCID
User nickname of the Profile.
Short description of the Profile defined by the Operator or MSP.
Profile Policy Rules
Type of profile-Operational, Provisioning or Test Profile
List of Managing SM-DP+(s)
Estimated installed size of the Profile (may be optional)
Device Change Configuration of the Profile (may be optional)
Additional proprietary information (may be optional)

Referring to signal flow 700, at 702, an AT command indicating a request to update a nickname is sent to UE 102. In one or more embodiments, the AT command is AT+CEUICCPMETAI=2, “iccid”, “nickname”.

At 704, a message is sent from the mobile station 112 to LPA 114 indicating the request to update a nickname of the profile. At 706, the LPA 114 sends an indication for the eUICC 116 to update the nickname.

At 708, a message is sent from the eUICC 116 to LPA 114 indicating a confirmation of the updated nickname. At 710, the LPA 114 sends to the MS 112 a response to update the nickname of the profile (e.g., the response indicating success, or failure, updating the nickname). At 712, MS 112 may send, to UE peripheral device 108, a confirmation (“OK”) indicating success updating the nickname, or an error, as further described herein.

Referring to signal flow 800, at 802, an AT command indicating a request for metadata information (e.g., a metadata query) to UE 102. In one or more embodiments, the AT command is AT+CEUICCPMETAI=1, “iccid”.

At 804, a message is sent from the mobile station 112 to LPA 114 indicating the metadata query. At 806, the LPA 114 sends an indication for the metadata query, which may also be referred to a request to read the profile metadata, to eUICC 116.

At 808, a message is sent from the eUICC 116 to LPA 114 indicating the profile metadata for displaying. At 810, the LPA 114 sends to the MS 112 a response indicating the requested metadata. At 812, MS 112 may send, to UE peripheral device 108, an AT command response that indicates the requested metadata (e.g., +CEUICCPMETAI: “iccid”, “state”, “profile_metadata”), as further described herein. When multiple metadata queries have been received or indicated by AT command at 802, one or more of 804, 806, 808, 810, and/or 812 may be repeated, for example for each metadata query of the multiple metadata queries.

At 816, MS 112 may send, to UE peripheral device 108, a confirmation (“OK”) indicating success providing the requested profile metadata information, as further described herein.

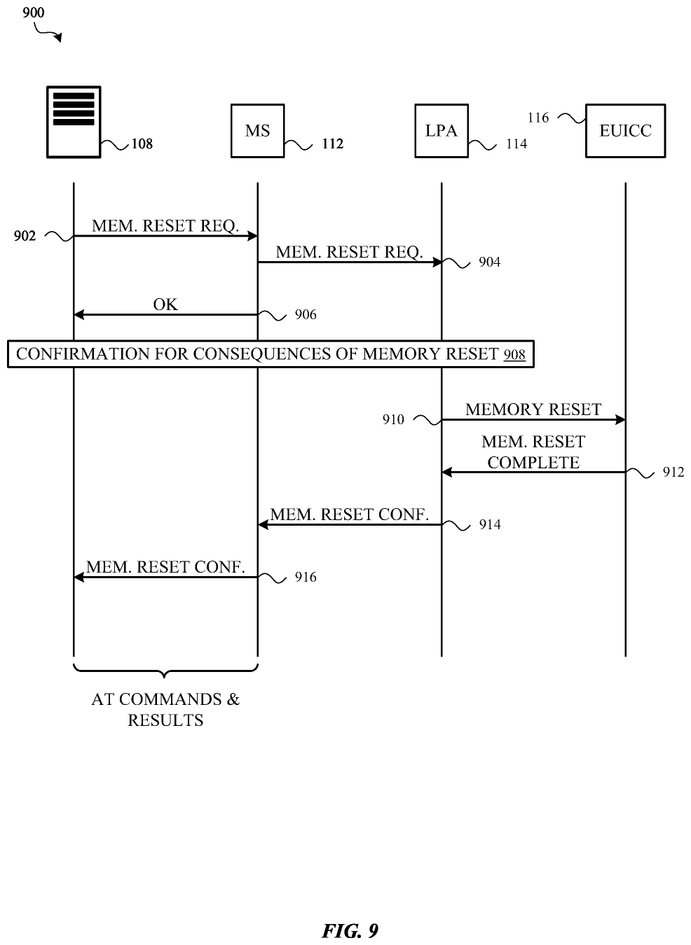

FIG. 9 shows an example signal flow 900, according to one or more aspects described herein. In one or more embodiments, signal flow 900, supports one or more aspects of profile activation and selection triggers for an eUICC, as further described herein. Signal flow 900 generally relates to resetting a memory of eUICC 116.

Signal flow 900 each illustrates communications between a UE peripheral device 108, a mobile station 112, an LPA 114, and an eUICC 116. In one or more embodiments, the LPA 114 and the eUICC 116 are a part of the mobile station 112. Mobile station 112 may be referred to as or be an example of UE 102. In some embodiments, mobile station 112 may include at least a portion of a local management interface, for example circuitry associated with local management interface 118. Additionally, or alternatively, in some embodiments, the UE peripheral device 108 may include at least a portion of the local management interface.

TABLE 4
+CEUICCMEMRESET parameter command syntax

| Command | Possible response(s) |
|---|---|
| +CEUICCMEMRESET | +CME ERROR: <err> |
| +CEUICCMEMRESET=? | |

Table 4 illustrates a +CEUICCMEMRESET parameter command syntax (e.g., for eUICC memory reset), including in relation to signal flow 900. In one or more embodiments, the AT command triggers the eUICC capable UE to request the LPA 114 to perform eUICC memory reset including associated profile metadata. In some embodiments, this requires the verification from the user for which the notification from the LPA 114 to the user (e.g., UE peripheral device 108) is triggered and then the user is prompted to respond to the same. Refer command +CEUICCUIV.

The AT command returns with the response depending upon whether the request is successfully sent to LPA 114 or not. The actual result for the memory reset will be displayed through the unsolicited result code +CEUICCMEMRESETU: <result>[,<cause>] once the procedure ends.

Defined values:

<result>: integer type; indicates the final result for eUICC memory reset.
0 Successfully deleted the profiles and the associated profile metadata.
1 Failed to reset the eUICC memory.

<cause>: integer type, indicating the error cause because of which the procedure to reset an eUICC has been terminated. <cause> will be present when <result>=1 Refer GSMA SGP.22.
0 unknown
1 nothing to delete
2 busy

Referring to signal flow 900, at 902, an AT command indicating a request to perform an eUICC memory reset is sent to UE 102. In one or more embodiments, the AT command is AT+CEUICCMEMRESET.

At 904, a message is sent from the mobile station 112 to LPA 114 indicating the request to perform the eUICC memory reset. At 906, a confirmation (“OK”) indicates that the AT command indicating the request to perform the eUICC memory reset was received.

At 908, in one or more embodiments, a confirmation of consequences for performing the eUICC memory reset may be obtaining by the LPA 114 from the UE peripheral device 108.

At 910 the LPA 114 sends an indication for the eUICC 116 to reset the eUICC memory. The eUICC 116 then send a response indicating that the memory reset operation is complete (e.g., upon complete of the memory rest at eUICC 116). At 914, the LPA 114 sends to the MS 112 a response confirming the memory reset. At 916, MS 112 may send, to UE peripheral device 108, an AT command response (e.g., +CEUICCPMEMRESETU:0) confirming the memory reset, as further described herein.

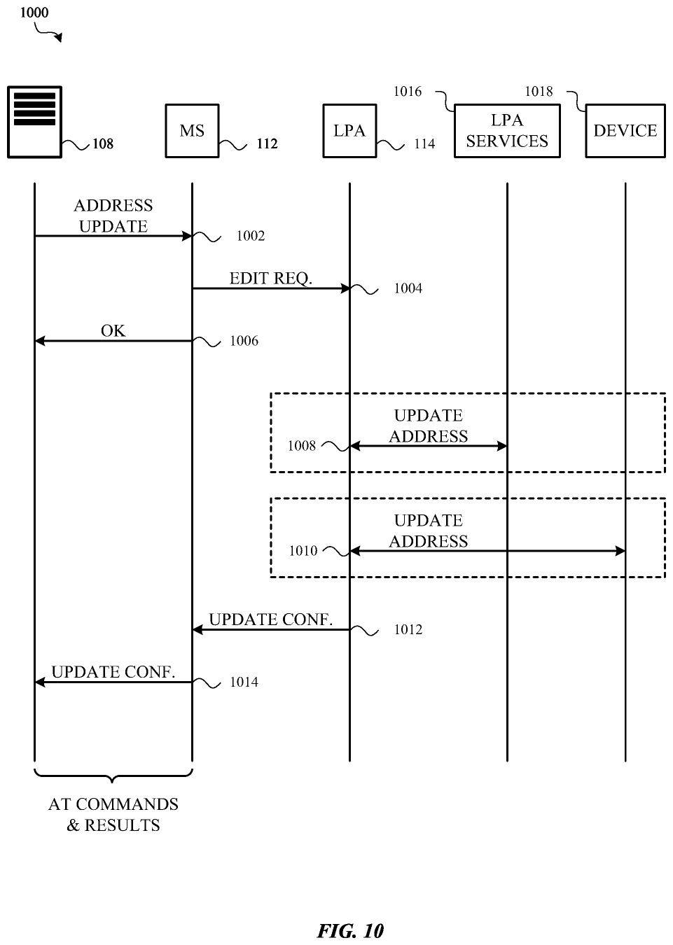

FIG. 10 shows an example signal flow 1000, according to one or more aspects described herein. In one or more embodiments, signal flow 1000, supports one or more aspects of profile activation and selection triggers for an eUICC, as further described herein. Signal flow 1000 generally relates to editing an SM-DP+ address (e.g., a default SM-DP+ address) on a eUICC (e.g. eUICC 116) or device (e.g., UE 102, such as a modem or baseband of UE 102).

Signal flow 1000 each illustrates communications between a UE peripheral device 108, a mobile station 112, an LPA 114, and LPA services 1016 or device 1018. In one or more embodiments, the LPA 114, the LPA services 1016, and device 1018 are a part of the mobile station 112. Mobile station 112 may be referred to as or be an example of UE 102. In some embodiments, mobile station 112 may include at least a portion of a local management interface, for example circuitry associated with local management interface 118. Additionally, or alternatively, in some embodiments, the UE peripheral device 108 may include at least a portion of the local management interface.

TABLE 5
+CEUICCUSMDPA parameter command syntax

| Command | Possible response(s) |
|---|---|
| +CEUICCUSMDPA=<smdp_address> | +CME ERROR: <err> |
| +CEUICCUSMDPA=? | |

Table 5 illustrates a +CEUICCUSMDPA parameter command syntax (e.g., for updating default SM-DP+ address), including in relation to signal flow 1000. In one or more embodiments, the AT command allows the user to edit a default SM-DP+ address on the eUICC (e.g., eUICC 116) or device (e.g., UE 102, such as a modem or baseband of UE 102). In some embodiments, this requires the verification of the user's intent for which the notification from LPA 114 to user is triggered and then the user is prompted to respond to the same. Refer command +CEUICCUIV.

The AT command returns with the response depending upon whether the request is successfully sent to LPA 114 or not. The actual result for updating the SM-DP+ address will be displayed through the unsolicited result code +CEUICCUSMDPAU: <result> once the procedure ends.

Defined values

<smdp_address>: string type, indicating the SM-DP+ address which will be replacing the default SM-DP+ address present in eUICC/device.

<result>: integer type; indicates the final result for eUICC memory reset.

| | |
|---|---|
| 0 | Successfully updated the SM-DP+ address. |
| 1 | Failed to update the SM-DP+ address. |

Referring to signal flow 1000, at 1002, an AT command indicating an address update request is sent to UE 102 by UE peripheral device 108. In one or more embodiments, the AT command is AT+CEUICCUSMDPA=“smdp_address”.

At 1004, a message is sent from the mobile station 112 to LPA 114 indicating the request to edit the SM-DP+ address. At 1006, MS 112 may send, to UE peripheral device 108, a confirmation (“OK”) indicating successful receipt of the AT command.

Following 1006, one of two address updates may be performed. In some embodiments, the SM-DP+ address is stored in eUICC 116, and the SM-DP+ address update is performed between LPA 114 and LPA services 1016. In some embodiments, the SM-DP+ address is stored in the another component of the device 1018 (e.g., UE 102), such as in a modem or baseband of device, and the SM-DP+ address update is performed between LPA 114 and device 1018.

At 1012, the LPA 114 sends to the MS 112 a response providing a confirmation of the edit to the SM-DP+ address. At 1014, MS 112 may send, to UE peripheral device 108, an AT command response confirming the edit to the SM-DP+ address (e.g., +CEUICCUSMDPAU:0), as further described herein.

Additional AT commands and AT command responses may request an ID of the eUICC (e.g., an EID), manage the pending notifications that are generated when a profile management operation has been success, enable or disable a notification through an unsolicited response, or any combination of these, further discussed below.

A first example includes, eUICC User Intent Verification (e.g., +CEUICCUIV).

TABLE 6
+CEUICCUIV parameter command syntax

| Command | Possible response(s) |
|---|---|
| +CEUICCUIV=<action>[,<user_response>[,< | +CME ERROR: <err> |
| iccid>]] | |
| +CEUICCUIV=? | +CEUICCUIV: (range of |
| | supported <action>s) |

The set command allows the enablement or disablement of a notification through an unsolicited response +CEUICCUIV: <operation>,<op_state>[,<iccid>] to the user (e.g., UE peripheral device 108) to verify an intent on the action triggered. This command also allows to respond to the prompt for verification.

The test command returns the list of <action>s that are triggered.

Defined values:

<action>: integer type.

| | |
|---|---|
| 0 | disable the unsolicited response +CEUICCUIV: |
| | <operation>,<op_state>[,<iccid>] |
| 1 | enable the unsolicited response +CEUICCUIV: |
| | <operation>,<op_state>[,<iccid>] |
| 2 | respond with the user's intent as verification for the action triggered |

<user_response>: integer type, indicating the response for the user's intent verification.

| | |
|---|---|
| 0 | user does not intent to verify the action |
| 1 | user intents to verify the action |

<iccid>: string type; specifies a unique number to identify a Profile in an eUICC.

<operation>: integer type, indicating the operation for which the verification of user's intent is required.

| | |
|---|---|
| 0 | Unknown |
| 1 | download and install Profile |
| 2 | enable profile |
| 3 | disable profile |
| 4 | delete profile |
| 5 | eUICC memory reset |
| 6 | update SM-DP+ address |

<op_state>: integer type, indicating the state for verification of user's intent for the particular operation.

| | |
|---|---|
| 0 | verification not required |
| 1 | verification required |

A second example includes, get eUICC ID (e.g., +CGEUICCID)

TABLE 7
+CGEUICCID parameter command syntax

| Command | Possible response(s) |
|---|---|
| +CGEUICCID | +CGEUICCID: <EID> |
| | +CME ERROR: <err> |
| +CGEUICCID=? | |

The set command triggers the eUICC capable UE to request the eUICC ID (EID) from eUICC present in the device. This function can be used (e.g., at any time) by the user to get the EID through LPA.

Defined values

<EID>: string type; indicates the eUICC identifier which is comprised of 32 digits where each digit is represented by one character in the set [0123456789]

Examples of valid EIDs are:

8900 1012 0123 4123 4012 3456 7890 1224
8900 1567 01020304 0506 0708 0910 1152
8904 4011 1122 3344 1122 3344 1122 3321
0090 9231 2229 9992 3581 2903 6544 3008

A third example includes, eSIM profile notification management (e.g., +CEUICCPNM)

TABLE 8
+ CEUICCPNM parameter command syntax

| Command | Possible response(s) |
|---|---|
| +CEUICCPNM=<operation>[,<seq_no>] | In case <operation>=0 |
| | [+CEUICCPNM: |
| | <seq_no1>,<profile_event>[,<iccid>] |
| | [<CR><LF>+CEUICCPNM: |
| | <seq_no2>,<profile_event>[,<iccid>] |
| | [...]]] |
| | +CME ERROR: <err> |
| +CEUICCPNM=? | +CEUICCPM: (range of supported |
| | <operation>s) |

The set command is to manage the pending notifications that are generated when a profile management operation has been successfully performed on the eUICC or when there is a progress of such an operation. When <operation>=0, the command returns the list of sequence numbers where each sequence number represents a pending notification. When <operation>=1, the command triggers the LPA 114 to send all the pending notifications to SM-DP+. When <operation>=2, the command triggers the LPA 114 to delete a particular pending information using the sequence number that was fetched through <operation>=0.

The test command returns the list of <operation>s.

Defined values:

<operation>: integer type, indicates the operation to be done for the notification management for the profiles installed in the eUICC.

| | |
|---|---|
| 0 | List pending notifications |
| 1 | Send all pending notifications to SM-DP+ |
| 2 | Delete a notification |

<iccid>: string type; specifies a unique number to identify a Profile in an eUICC.

<seq_no>: integer type, indicating the sequence number which represents a pending notification.

<profile_event>: integer type, indicating the profile event which is a notification generated by eUICC.

| | |
|---|---|
| 0 | Notification on Install |
| 1 | Notification on Local Enable |
| 2 | Notification on Local Disable |
| 3 | Notification on Local Delete |
| 4 | Notification on Rpm Enable |
| 5 | Notification on Rpm Disable |
| 6 | Notification on Rpm Delete |
| 7 | Load Rpm Package Result |

Various specific AT command names are used herein, including at least +CEUICCPD, +CEUICCPM, +CEUICCPMETAI, +CEUICCMEMRESET, +CEUICCUSMDPA, +CEUICCUIV, +CGEUICCID, and +CEUICCPNM. Each of these AT command names are merely exemplary, and additional, fewer, or different AT commands have be used, and may have different names, consistent with the disclosure herein.

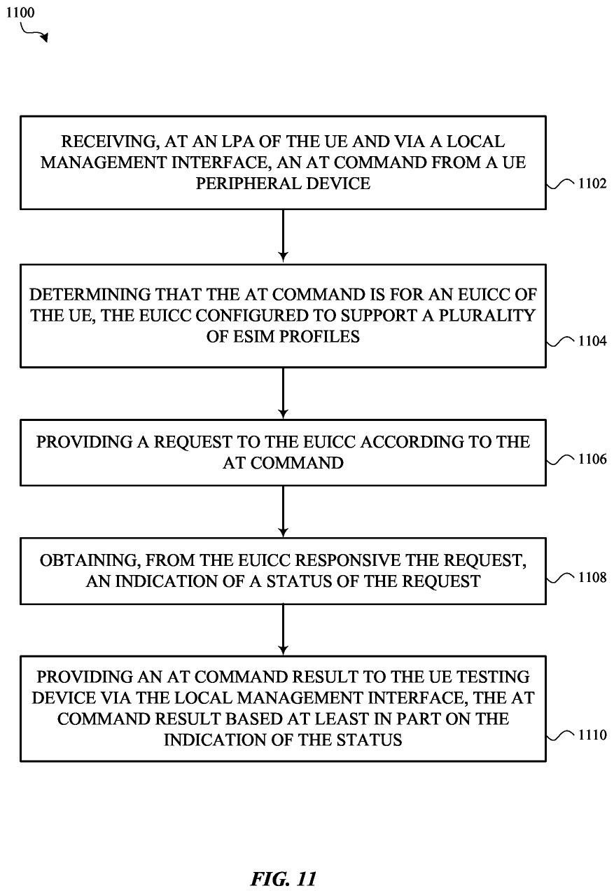

FIG. 11 shows an example method 1100 of wireless communication by a UE, according to one or more aspects described herein. In one or more embodiments, method 1100, supports one or more aspects of profile activation and selection triggers for an eUICC, as further described herein. In some cases, the UE may be the UE 102, wireless device 1402, or one of the other UEs described herein. The method 1100 may be performed using a processor, a transceiver (or a main radio), or other components of the UE.

At 1102, the method 1100 includes receiving, at a LPA of the UE and via a local management interface, an AT command from a UE peripheral device.

At 1104, the method 1100 includes determining that the AT command is for an eUICC of the UE, the eUICC configured to support a plurality of eSIM profiles.

At 1106, the method 1100 includes providing a request to the eUICC according to the AT command.

At 1108, the method 1100 includes obtaining, from the eUICC responsive the request, an indication of a status of the request.

At 1110, the method 1100 includes providing an AT command response to the UE peripheral device via the local management interface, the AT command response based at least in part on the indication of the status.

In one or more embodiments, the method further includes determining that the AT command includes a request to perform an activation code procedure to download and install an eSIM profile in the eUICC, where the request provided to the eUICC includes an indication to initiate an activation code download procedure.

In one or more embodiments, the method further includes providing, via the local management interface and responsive to the request to perform the activation code procedure, an AT command response indicating a confirmation code request to the UE peripheral device, where the AT command includes a first AT command; and receiving, from the UE peripheral device in response to the confirmation code request, a second AT command identifying a confirmation code.

In one or more embodiments, the method further includes providing, via the local management interface and responsive to verifying the eSIM profile, a request for a PIN from the UE peripheral device, where the AT command includes a first AT command; and receiving, from the UE peripheral device in response to the request for the PIN, a second AT command identifying the PIN.

In one or more embodiments, the method further includes identifying a failure associated with the download or the install of the eSIM profile; and providing, via the local management interface and responsive to identifying the failure, an AT command response identifying a type of the failure.

In one or more embodiments, the method further includes determining that the AT command includes a request to enable the eSIM profile in the eUICC, where the request provided to the eUICC includes the request to enable the eSIM profile, and the AT command response indicates a success or a failure of enabling the eSIM profile, where the eSIM profile is a first eSIM profile.

In one or more embodiments, the method further includes determining, based at least in part on the request to enable the first eSIM profile, that a second eSIM profile has an enabled status, where the AT command response indicates the failure of enabling the first eSIM profile.

In one or more embodiments, the method further includes determining that the AT command includes a request to disable or delete an eSIM profile in the eUICC, where the request provided to the eUICC includes the request to disable or delete the eSIM profile, and the AT command response indicates a success or a failure of disabling or deleting the eSIM profile.

In one or more embodiments, the method further includes determining, based at least in part on the request to disable or delete the eSIM profile, that a profile policy disallows disabling or deleting the eSIM profile, where the AT command response indicates the failure of disabling or deleting the eSIM profile.

In one or more embodiments, the method further includes determining, based at least in part on the request to disable or delete the eSIM profile, that the eSIM profile has been disabled or deleted, where the AT command response indicates the success of disabling or deleting the eSIM profile.

In one or more embodiments, the method further includes determining that the AT command includes one or more of a request to add or update a nickname of an eSIM profile of the plurality of eSIM profiles, read metadata of the eSIM profile, perform a memory reset for the eUICC, or update a subscription manager address (e.g., a SM-DP+ address, which may be a default SM-DP+ address), where the AT command response includes a confirmation of the one or more the request to add or update the nickname of the eSIM profile, read metadata of the eSIM profile, perform the memory reset, or update the subscription manager address.

In one or more embodiments, the method further includes determining that the AT command comprises a notification management command, wherein the request provided to the eUICC includes a request for a list of sequence numbers associated with one or more pending notifications, a request to send the one or more pending notifications to a SM-DP+, or a request to delete at least one of the one or more pending notifications.

In one or more embodiments, the method further includes determining that the AT command includes a request to provide an EID from the eUICC, wherein the request provided to the eUICC comprises the request to provide the EID.

In some embodiments, the eUICC includes the LPA. In some embodiments, a modem or base band of the UE includes the LPA.

The method 1100 may be variously embodied, extended, or adapted, as described in the following paragraphs and elsewhere in this description.

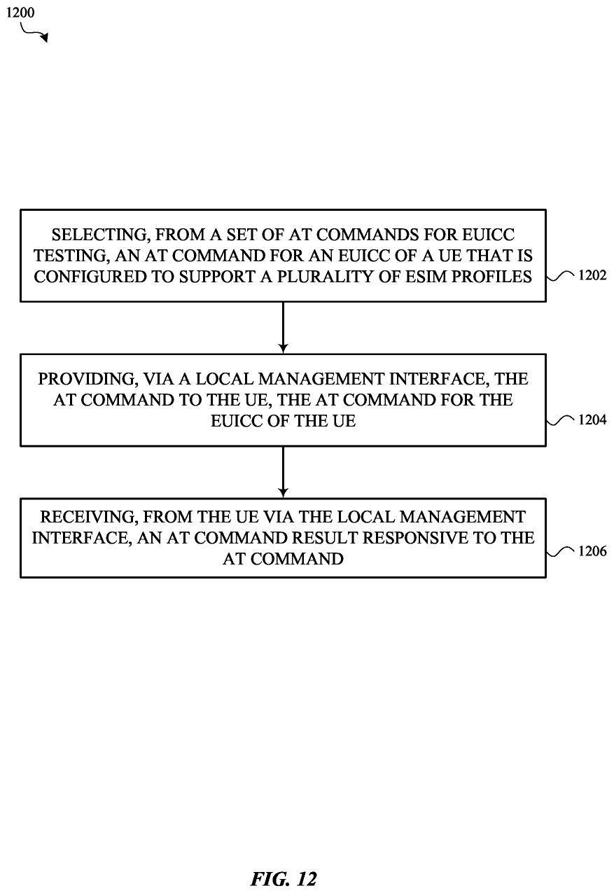

FIG. 12 shows an example method 1200 of wireless communication by a UE peripheral device, according to one or more aspects described herein. In one or more embodiments, method 1200, supports one or more aspects of profile activation and selection triggers for an eUICC, as further described herein. In some cases, the UE peripheral device may be the UE peripheral device 108, UE peripheral device 1420, or one of the other user devices or UE peripheral device described herein. The method 1200 may be performed using a processor, a transceiver, or other components of the UE peripheral device.

At 1202, the method 1200 includes selecting, from a set of AT commands for eUICC testing, an AT command for an eUICC of a UE that is configured to support a plurality of eSIM profiles.

At 1204, the method 1200 includes providing, via a local management interface, the AT command to the UE the AT command for the eUICC of the UE that is configured to support a plurality of eSIM profiles.

At 1206, the method 1200 includes receiving, from the UE via the local management interface, an AT command response responsive to the AT command.

In some embodiments, the AT command includes a request to perform an activation code procedure to download and install an eSIM profile in the eUICC.

In one or more embodiments, the method further includes receiving, via the local management interface and responsive to the request to perform the activation code procedure, an AT command response indicating a confirmation code request, where the AT command includes a first AT command; determining a confirmation code in response to the confirmation code request; and transmitting, via the local management interface and in response to the confirmation code request, a second AT command identifying the confirmation code.

In one or more embodiments, the method further includes receiving, via the local management interface and in response to the request to perform the activation code procedure, a request for a PIN, where the AT command includes a first AT command; and transmitting, via the local management interface and in response to the request for the PIN, a second AT command identifying the PIN.

In some embodiments, the AT command includes a request to enable, disable, or delete a first eSIM profile; and the AT command response indicates a success or a failure of enabling, disabling, or deleting the first eSIM profile.

In one or more embodiments, the method further includes determining, based at least in part on the AT command response, that a second eSIM profile has an enabled status, where the AT command response indicates the failure of enabling the first eSIM profile.

In some embodiments, the AT command includes one or more of a request to update a nickname of an eSIM profile, read metadata of the eSIM profile, perform a memory reset for the eUICC, or update a subscription manager address, where the AT command response includes a confirmation of the one or more the request to update the nickname of the eSIM profile, read metadata of the eSIM profile, perform the memory reset, or update the subscription manager address.

The method 1200 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors of the electronic device, to perform one or more elements of the method 1100, or 1200. In the context of method 1100, this non-transitory computer-readable media may be, for example, a memory of a UE (such as a memory 1406 of a wireless device 1402 that is a UE, as described herein). In the context of method 1200, this non-transitory computer-readable media may be, for example, a memory of a UE peripheral device (such as a memory 1424 of a UE peripheral device 1420, as described herein).

Embodiments contemplated herein include an apparatus having logic, modules, or circuitry to perform one or more elements of the method 1100, or 1200. In the context of method 1100, this apparatus may be, for example, an apparatus of a UE (such as a wireless device 1402 that is a UE). In the context of method 1200, this apparatus may be, for example, an apparatus of a UE peripheral device (such as a UE peripheral device 1420, as described herein).

Embodiments contemplated herein include an apparatus having one or more processors and one or more computer-readable media, using or storing instructions that, when executed by the one or more processors, cause the one or more processors to perform one or more elements of the method 1100, or 1200. In the context of method 1100, this apparatus may be, for example, an apparatus of a UE (such as a wireless device 1402 that is a UE, as described herein). In the context of the method 1200, this apparatus may be, for example, an apparatus of a UE peripheral device (such as a UE peripheral device 1420, as described herein).

Embodiments contemplated herein include a signal as described in or related to one or more elements of the method 1100, or 1200.

Embodiments contemplated herein include a computer program or computer program product having instructions, wherein execution of the program by a processor causes the processor to carry out one or more elements of the method 1100, or 1200. In the context of method 1100, the processor may be a processor of a UE (such as a processor(s) 1404 of a wireless device 1402 that is a UE, as described herein), and the instructions may be, for example, located in the processor and/or on a memory of the UE (such as a memory 1406 of a wireless device 1402 that is a UE, as described herein). In the context of method 1200, the processor may be a processor of a UE peripheral device (such as a processor(s) 1422 of a UE peripheral device 1420, as described herein), and the instructions may be, for example, located in the processor and/or on a memory of the UE peripheral device (such as a memory 1424 of a UE peripheral device 1420, as described herein).

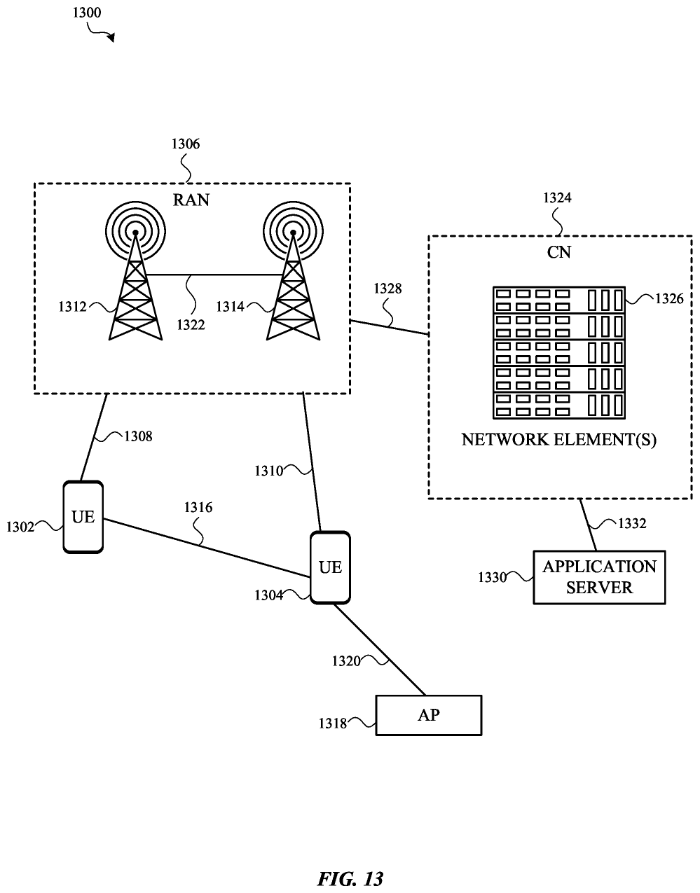

FIG. 13 illustrates an example architecture of a wireless communication system, according to embodiments described herein. The following description is provided for an example wireless communication system 1300 that operates in conjunction with the LTE system standards or specifications and/or 5G or NR system standards or specifications, as provided by 3GPP technical specifications.

As shown, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks) but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more network devices, such as base station 1312 and base station 1314, that enable the connection 1308 and connection 1310.

In this example, the connection 1308 and connection 1310 are air interfaces to enable such communicative coupling and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more network devices of a RAN (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more network devices of a RAN (e.g., two or more gNBs and the like) that connect to the 5GC, between a base station 1312 (e.g., a gNB) connecting to the 5GC and an eNB, and/or between two eNBs connecting to the 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VoIP sessions, group communication sessions, etc.) for the UE 1302 and UE 1304 via the CN 1324. The application server 1330 may communicate with the CN 1324 through an IP communications interface 1332.

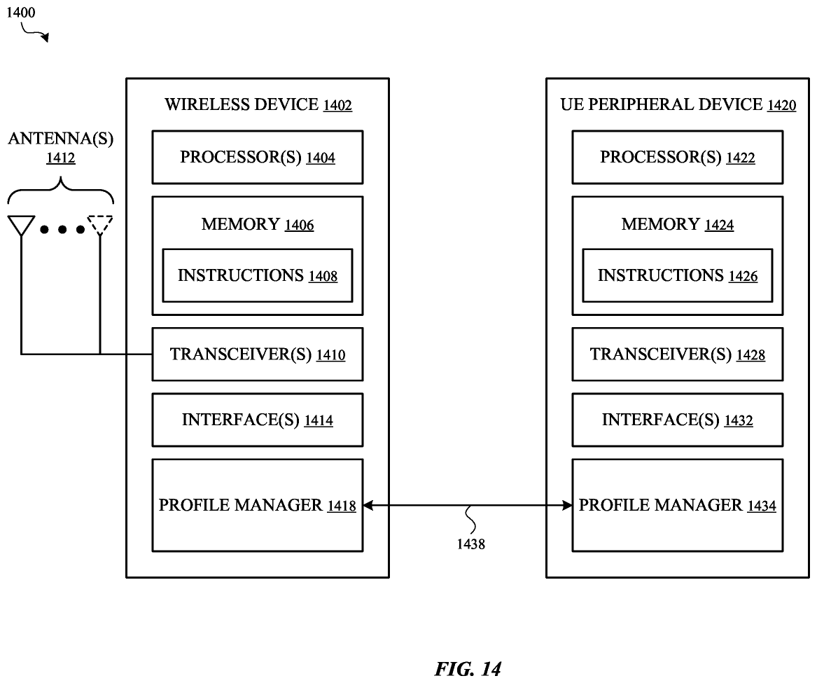

FIG. 14 illustrates an example system 1400 for performing signaling 1438 between a wireless device 1402 and a UE peripheral device 1420, according to embodiments described herein. The system 1400 may be a portion of a wireless communication system as herein described. The wireless device 1402 may be, for example, a UE of a wireless communication system. The UE peripheral device 1420 may be a user device, for example used during manufacture or shortly thereafter in connection with conformance testing or other testing to determine the correct performance of the wireless device 1402.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 (also collectively referred to as a transceiver 1410) that may include radio frequency (RF) transmitter and/or receiver circuitry that use the antenna(s) 1412 of the wireless device 1402 to facilitate signaling (e.g., the signaling 1438) to and/or from the wireless device 1402 with other devices (e.g., the UE peripheral device 1420) according to corresponding RATs.

The wireless device 1402 may include one or more antenna(s) 1412 (e.g., one, two, four, eight, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi-user MIMO (MU-MIMO) methods (where individual data streams may be directed to individual (different) receivers in different locations in the spatial domain).

In some embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1416. The interface(s) 1416 may be used to provide input to or output from the wireless device 1402. For example, a wireless device 1402 that is a UE may include interface(s) 1416 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include profile manager 1418. The profile manager 1418 may be implemented via hardware, software, or combinations thereof. For example, the profile manager 1418 may be implemented as a processor, circuit, and/or instructions 1408 stored in the memory 1406 and executed by the processor(s) 1404. In some examples, the profile manager 1418 may be integrated within the processor(s) 1404 and/or the transceiver(s) 1410. For example, the profile manager 1418 may be implemented by a combination of software components (e.g., executed by a DSP or a general processor) and hardware components (e.g., logic gates and circuitry) within the processor(s) 1404 or the transceiver(s) 1410.

The profile manager 1418 may be used for various aspects of the present disclosure, for example, aspects of FIGS. 1-14, from a wireless device or UE perspective. The profile manager 1418 may be configured to, for example, perform receiving, at a LPA of the UE and via a local management interface, an AT command from a UE peripheral device; determining that the AT command is for an eUICC of the UE, the eUICC configured to support a plurality of eSIM profiles; providing a request to the eUICC according to the AT command; obtaining, from the eUICC responsive the request, an indication of a status of the request; providing an AT command response to the UE peripheral device via the local management interface, the AT command response based at least in part on the indication of the status.

The UE peripheral device 1420 may include one or more processor(s) 1422. The processor(s) 1422 may execute instructions such that various operations of the UE peripheral device 1420 are performed, as described herein. The processor(s) 1422 may include one or more baseband processors implemented using, for example, a CPU, a DSP, an ASIC, a controller, an FPGA device, another hardware device, a firmware device, or any combination thereof configured to perform the operations described herein.

The UE peripheral device 1420 may include a memory 1424. The memory 1424 may be a non-transitory computer-readable storage medium that stores instructions 1426 (which may include, for example, the instructions being executed by the processor(s) 1422). The instructions 1426 may also be referred to as program code or a computer program. The memory 1424 may also store data used by, and results computed by, the processor(s) 1422.

The UE peripheral device 1420 may include one or more transceiver(s) 1428 (also collectively referred to as a transceiver 1428) that may include RF transmitter and/or receiver circuitry that use the antenna(s) 1430 of the UE peripheral device 1420 to facilitate signaling (e.g., the signaling 1416) to and/or from the UE peripheral device 1420 with other devices (e.g., the wireless device 1402) according to corresponding RATs.

The UE peripheral device 1420 may include one or more antenna(s) 1430 (e.g., one, two, four, or more). In embodiments having multiple antenna(s) 1430, the UE peripheral device 1420 may perform MIMO, digital beamforming, analog beamforming, beam steering, etc., as has been described.

The UE peripheral device 1420 may include one or more interface(s) 1432. The interface(s) 1432 may be used to provide input to or output from the UE peripheral device 1420. For example, a UE peripheral device 1420 of a RAN (e.g., a base station, a radio head, etc.) may include interface(s) 1432 made up of transmitters, receivers, and other circuitry (e.g., other than the transceiver(s) 1428/antenna(s) 1430 already described) that enables the UE peripheral device 1420 to communicate with other equipment in a network, and/or that enables the UE peripheral device 1420 to communicate with external networks, computers, databases, and the like for purposes of operations, administration, and maintenance of the UE peripheral device 1420 or other equipment operably connected thereto.

The UE peripheral device 1420 may include at least one of profile manager 1434. The profile manager 1434 may be implemented via hardware, software, or combinations thereof. For example, the profile manager 1434 may be implemented as a processor, circuit, and/or instructions 1426 stored in the memory 1424 and executed by the processor(s) 1422. In some examples, the profile manager 1434 may be integrated within the processor(s) 1422 and/or the transceiver(s) 1428. For example, the profile manager 1434 may be implemented by a combination of software components (e.g., executed by a DSP or a general processor) and hardware components (e.g., logic gates and circuitry) within the processor(s) 1422 or the transceiver(s) 1428.

The profile manager 1434 may be used for various aspects of the present disclosure, for example, aspects of FIGS. 1-14, from a UE peripheral device perspective. The profile manager 1434 may be configured to, for example, perform selecting, from a set of AT commands for eUICC testing, an AT command for an eUICC of a UE that is configured to support a plurality of eSIM profiles; providing, via a local management interface, the AT command to the UE the AT command for the eUICC of the UE; receiving, from the UE via the local management interface, an AT command response responsive to the AT command.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, UE peripheral device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein but may be modified within the scope and equivalents of the appended claims.

1. A user equipment (UE), comprising:
an embedded universal integrated circuit card (eUICC);
a local profile assistant (LPA) coupled with the eUICC, the LPA configured to support a local management interface toward a user; and
a processor configured to cause the UE to,
receive, via a local management interface, an attention (AT) command from a UE peripheral device;
determine that the AT command is for the eUICC, the eUICC configured to support a plurality of embedded subscriber identity module (eSIM) profiles;
provide a request to the eUICC according to the AT command;
obtain, from the eUICC responsive the request, an indication of a status of the request; and
provide an AT command response to the UE peripheral device via the local management interface, the AT command response based at least in part on the indication of the status.

2. The UE of claim 1, wherein the processor is further configured to cause the UE to:
determine that the AT command comprises a request to perform an activation code procedure to download and install an eSIM profile in the eUICC, wherein the request provided to the eUICC comprises an indication to initiate an activation code download procedure.

3. The UE of claim 2, wherein the processor is further configured to cause the UE to:
provide, via the local management interface and responsive to the request to perform the activation code procedure, an AT command response indicating a confirmation code request to the UE peripheral device, wherein the AT command comprises a first AT command; and
receive, from the UE peripheral device in response to the confirmation code request, a second AT command identifying a confirmation code.

4. The UE of claim 2, wherein the processor is further configured to cause the UE to:
provide, via the local management interface and responsive to verifying the eSIM profile, a request for a personal identification number (PIN) from the UE peripheral device, wherein the AT command comprises a first AT command; and
receive, from the UE peripheral device in response to the request for the PIN, a second AT command identifying the PIN.

5. The UE of claim 2, wherein the processor is further configured to cause the UE to:
identify a failure associated with the download or the install of the eSIM profile; and
provide, via the local management interface and responsive to identifying the failure, an AT command response identifying a type of the failure.

6. The UE of claim 1, wherein the processor is further configured to cause the UE to:
determine that the AT command comprises a request to enable an eSIM profile in the eUICC, wherein the request provided to the eUICC comprises the request to enable the eSIM profile, and the AT command response indicates a success or a failure of enabling the eSIM profile.

7. The UE of claim 1, wherein the processor is further configured to cause the UE to:
determine that the AT command comprises a request to disable a eSIM profile in the eUICC, wherein the request provided to the eUICC comprises the request to disable the eSIM profile, and the AT command response indicates a success or a failure of disabling the eSIM profile.

8. The UE of claim 7, wherein the processor is further configured to cause the UE to:
determine, based at least in part on the request to disable the eSIM profile, that a profile policy disallows disabling the eSIM profile, wherein the AT command response indicates the failure of disabling the eSIM profile.

9. The UE of claim 7, wherein the processor is further configured to cause the UE to:
determine, based at least in part on the request to disable the eSIM profile, that the eSIM profile has been disabled, wherein the AT command response indicates the success of disabling the eSIM profile.

10. The UE of claim 1, wherein the processor is further configured to cause the UE to:
determine that the AT command comprises a request to delete an eSIM profile in the eUICC, wherein the request provided to the eUICC comprises the request to delete the eSIM profile, and the AT command response indicates a success or a failure of deleting the eSIM profile.

11. The UE of claim 10, wherein the processor is further configured to cause the UE to:
determine, based at least in part on the request to delete the eSIM profile, that a profile policy disallows deleting the eSIM profile, wherein the AT command response indicates the failure of deleting the eSIM profile.

12. The UE of claim 1, wherein the processor is further configured to cause the UE to:
determine that the AT command comprises one or more of a request to add or update a nickname of an eSIM profile of the plurality of eSIM profiles, read metadata of the eSIM profile, perform a memory reset for the eUICC, or update a default subscription manager data preparation platform (SM-DP+) address, wherein the AT command response comprises a confirmation of the one or more the request to add or update the nickname of the eSIM profile, read metadata of the eSIM profile, perform the memory reset, or update the default SM-DP+ address.

13. The UE of claim 1, wherein the processor is further configured to cause the UE to:
determine that the AT command comprises a notification management command, wherein the request provided to the eUICC comprises a request for a list of sequence numbers associated with one or more pending notifications, a request to send the one or more pending notifications to a subscription manager data preparation platform (SM-DP+), or a request to delete at least one of the one or more pending notifications.

14. The UE of claim 1, wherein the processor is further configured to cause the UE to:
determine that the AT command comprises a request to provide an eUICC identifier (EID) from the eUICC, wherein the request provided to the eUICC comprises the request to provide the EID.

15. The UE of claim 1, the eUICC comprises the LPA, or a modem of the UE comprises the LPA.

16. A user equipment (UE) peripheral device, comprising:
a local management interface configured to communicate with a UE; and
a processor configured to cause the UE peripheral device to,
select, from a set of attention (AT) commands for embedded universal integrated circuit card (eUICC) testing, an AT command for an eUICC of a UE that is configured to support a plurality of embedded subscriber identity module (eSIM) profiles;
provide, via a local management interface, the AT command to the UE, the AT command for the eUICC of the UE; and
receive, from the UE via the local management interface, an AT command response responsive to the AT command.

17. The UE peripheral device of claim 16, wherein the AT command comprises a request to perform an activation code procedure to download and install an eSIM profile in the eUICC.

18. The UE peripheral device of claim 16, wherein:
the AT command comprises a request to enable, disable, or delete a eSIM profile; and
the AT command response indicates a success or a failure of enabling, disabling, or deleting the eSIM profile.

19. The UE peripheral device of claim 16, wherein the AT command comprises one or more of a request to update a nickname of an eSIM profile, read metadata of the eSIM profile, perform a memory reset for the eUICC, or update a subscription manager address, wherein the AT command response comprises a confirmation of the one or more the request to update the nickname of the eSIM profile, read metadata of the eSIM profile, perform the memory reset, or update the subscription manager address.

20. A method of controlling a user equipment (UE), comprising:
receiving, via a local management interface, an attention (AT) command from a UE peripheral device;
determining that the AT command is for an embedded universal integrated circuit card (eUICC), the eUICC configured to support a plurality of embedded subscriber identity module (eSIM) profiles;
providing a request to the eUICC according to the AT command;
obtaining, from the eUICC responsive the request, an indication of a status of the request; and
providing an AT command response to the UE peripheral device via the local management interface, the AT command response based at least in part on the indication of the status.
